(19) United States
(12) Patent Application Publication
(10) Pub. No.: US 2012/0303527 A1
(43) Pub. Date: Nov. 29, 2012

(54) PROCESS AND HOST AND COMPUTER SYSTEM FOR CARD-FREE AUTHENTICATION

(75) Inventors: Thomas Karlisch, Salzkotten (DE); Udo Pape-Kampmeier, Paderborn (DE)

(73) Assignee: WINCOR NIXDORF INTERNATIONAL GMBH, Paderborn (DE)

(21) Appl. No.: 13/480,989

(22) Filed: May 25, 2012

(30) Foreign Application Priority Data
May 26, 2011 (DE) 10 2011 103 292.8

(51) Int. Cl. G06Q 20/40; H04W 12/06; H04B 5/00; G06Q 20/32; G06Q 20/16

(52) U.S. Cl. 705/44

(57) ABSTRACT

A terminal of acceptance (1; 2) transmits a first identification information entered by the user at the terminal of acceptance or prompted by the terminal of acceptance and/or an information derived from first identification information to the central server (3); the central server (3) transmits a user identification message to the telecommunications number assigned to the user identification information, if the user is successfully identified by the central server based on the transmitted first identification information and/or based on the derived information; the terminal of acceptance (1, 2) prompts the user to enter the user identification message transmitted; and the user is authenticated using a second identification information and is authorized to execute the transaction, if the user identification message entered by the user at the terminal of acceptance corresponds to user identification message transmitted by the central server (3).

### CROSS REFERENCE TO RELATED APPLICATIONS

This application claims priority to German patent application no. 10 2011 103 292.8, filed on 26 May 2011, entitled “Process and Host and Computer System for Card-Free Authentication”, which is hereby incorporated by reference.

### BACKGROUND OF THE INVENTION

1. Field of the Invention

The invention relates to a method for card-free authentication of a user against at an acceptance point (hereinafter also terminal of acceptance), such as a cash machine or automatic teller machine (ATM) or a point-of-sale (POS) terminal that communicates with a central host.

2. Discussion

Cash machines, banking machines or ATMs commonly use a card reader as means for identification, by means of which a user can identify himself or herself using a bank card. This is usually done by entering a personal identification number (PIN). The identification data of the bank card and the PIN are transmitted over a secure communication link to a central location such as a service computer (host) of a commercial bank. There, the identification data and the PIN are checked. In the case of a successful identification and authentication of the user the user is authorized to perform the requested transaction, for example, a cash withdrawal, cash deposit, bank transfer or creation of a bank statement.

With the increasing use of cashless payment methods similar authentication procedures have been introduced also at point-of-sale (POS) terminals, for example in supermarkets.

Here, the safety of the identification process and of the transaction is of high importance. A problem becoming more and more important in this case is in particular the so-called skimming, which is attempting fraud to obtain card data and the aforementioned means of identification. For this, it is necessary to read out the card data stored in the magnetic stripe of the bank card, and the identification means.

Because of the high number of issued bank cards the authentication processes should be changed to improve security, while use of the existing infrastructure and standards shall not be changed as far as possible.

### SUMMARY OF THE INVENTION

It is an object of the present invention to provide a method for card-free authentication of a user at an acceptance point (terminal of acceptance), to thereby accomplish a higher security in a simple manner. According to further aspects of the present invention also a host configured for this purpose as a central point, a terminal of acceptance designed for this purpose and a corresponding system configured for this purpose shall be provided.

A method of the present invention for card-free authentication of a user by means of a terminal of acceptance for executing a transaction at or by means of the terminal of acceptance is executed in a system environment comprising a central server, in particular a host storing for each user a unique user identification information, a telecommunications number and card details, a plurality of terminals of acceptance, such as banking machines or ATMs or point-of-sale (POS) terminals, and a secure communication link between the central server and the respective terminals of acceptance.

In this method the user at first inputs a first identification information to the terminal of acceptance, or this first identification information is requested by the terminal of acceptance, preferably automatically, e.g. if the user is approaching the terminal of acceptance in a suitable manner. This first identification information may in particular be a numeric or alphanumeric identification information provided to the user by the central server after a successful registration at the terminal of acceptance and which can easily be remembered and entered into the terminal of acceptance, for example via a keyboard, such as an EPP (Encrypting PIN Pad, also an Encrypting PIN keypad), as this is available e.g. at ATMs, POS terminals and payment terminals. This user identification information may also be stored on an identification means which is carried by the user and is adapted to automatically communicate the first identification information on request by the terminal of acceptance to the latter, for example, in a wireless manner or using rf-signals. In a first step of the process the terminal of acceptance transmits the thus inputted first identification information and/or information derived from it to the central server (host) via a secure communication link, preferably information, which has been derived or computed based on a predetermined calculation rule or algorithm.

Based on the thus transmitted first identification information and/or based on the derived (computed) information, the central server then determines whether the user can be identified successfully. For this purpose, for example, conventional identification methods are used, for example, a comparison of the transmitted identification information with the user identification information stored at the central server for the respective user. If the user can be successfully identified at the central server based on the first identification information, the central server transmits a user identification message to the telecommunications number associated with the user information and stored at the central server for the user that has been successfully identified.

Further the terminal of acceptance prompts or requests the user to enter or input the user identification message transmitted to the user. For this purpose, the terminal of acceptance can receive a message from the central server after successful identification of the user confirming the successful identification and triggering the prompt. After entering this user identification message that has been transmitted an authentication of the user based on a second identification information is performed, which e.g. is associated with or corresponds to a PIN associated with the user or his or her bank card. It is preferred for this purpose that the user identification message, which has been entered into the terminal of acceptance by the user upon request, is transmitted to the central server, where it is compared with the user identification message, which has been transmitted to the telecommunications number assigned to the user. If a match is determined, this is notified and confirmed to the terminal of acceptance and the terminal of acceptance can then continue identifying the user in the conventional manner based on the second identification information, for example, based on the PIN further entered by the user and using conventional identification steps. Further, for this purpose also the card data of the user identified in the first step can be transmitted, which are then used in the usual manner to authenticate the user based on the second identification information input by the user for authentication.

The advantage of this method is that the authentication of the user can be performed without a card, but taking the utmost use of existing infrastructure (bank card with PIN; host computer having access to the data stored for the user) can be used. As it is not necessary to read out card data stored on a magnetic stripe card from the bank card or similar information, a major weak point against skimming attacks is turned off. Even if anyone would use the telecommunication number, which is associated with the user, in an unauthorized manner, for example by simultaneous theft of the mobile phone of the user, additional safety margins and measures exist that can prevent an unauthorized execution of the transaction. The reason is that because the starting point of a successful authentication is still entering the first identification information that was made available to the user and is kept confidential, for example, via a separate e-mail or mail or in the form of a bank card sticker with identification function and this first identification information is not easily available to the unauthorized user. Namely even if an unauthorized user would steal the mobile telephone or the like of the authorized user, the unauthorized user would still not be aware of this user identification information identifying the authorized user. Furthermore, additional security barriers are provide at most telecommunication terminals to which a telecommunications number is assigned, such as mobile phones, smartphones or tablet PCs with telephone function, such as device passwords or login passwords. Furthermore, permission means for allowing use of such telecommunication terminals in the event of theft can be blocked quite easily, for example, by blocking the SIM card or blocking the telecommunication number. This can be done centrally, for example, also by the central server performing the process according to the present invention or this can be triggered by the central server.

According to a preferred embodiment, the user identification message is transmitted from the central server via a telecommunications service to a mobile telecommunication terminal that corresponds to telecommunication number stored at the central server for the user. Particularly preferable the telecommunication number is a telephone number of a mobile phone, smartphone, tablet computer with telephone function or the like. Such mobile telecommunications terminals are practically always carried by the user and are thus constantly available for an authentication process. In particular a mobile short message service can be used to transmit the user identification information.

A particularly simple use can be implemented if the user identification information is an SMS (mobile short message services) or similar message with numeric or alphanumeric information. Even elderly people are nowadays familiar with such mobile short message services or related messaging services, so that according to the present invention a card-free authentication is readily possible also for elderly users. To enter the first identification information, the user thus just needs to read the short message sent to his or her mobile phone, smartphone or the like and just needs to enter the numeric or alphanumeric information contained in this message to the terminal of acceptance, for example, via an EPP. Of course also more complex user identification messages be transmitted using mobile short message services. According to further aspects of the present invention also the transmission of additional or alternative graphical information is conceived, in particular of identification matrix codes, which can be used as the first identification information after being displayed on the display of the mobile telecommunication terminal and after being read out using an optical detection device or optical reader of the terminal of acceptance.

In principle, according to a related aspect of the present invention, however, also the transmission of a user identification message to a mobile telecommunication terminal of the user by means of wireless Internet-based telecommunication services may be used, in particular in the form of an email or short message with numeric or alphanumeric information, similar to the aforementioned SMS, and/or by means of another graphical identification information, for example in the form of an identification matrix code. According to such an embodiment, the user would be registered at the central server additionally by means of an IP-address uniquely stored at the central server or in a database thereof and uniquely associated to the user. Of course, messages or information transmitted by Internet-based telecommunication services can be retrieved and displayed by means of and on any browser or news programs. However, in general it is conceived that by means of additional security measures that can also be integrated into the telecommunication terminal, the SIM card and/or software of the user, and/or by means of encryption algorithms an adequate security can be guaranteed to the user identification message to enable transmission of the user identification information using an Internet-based telecommunications service.

According to another preferred embodiment, the user identification information is provided to the user by the transfer of an electronic identification means provided, for example, by mail or a Postldent-process (a service rendered by the German Post for handing-out a registered letter to recipients only at registered post offices and upon identification of the recipient by means of a pass-port) or by means of similar secure confidential process, but also embodied by means of an electronic chip or RFID tag, which can be carried along by the user also on a bank card or payment card, and which is suited for a contact-free (e.g. wireless) exchange of data with the terminal of acceptance. The advantage is that the query (prompting) of the first identification information by the terminal of acceptance can also be performed automatically, in particular in a contact-free manner, such as when the user has approached the terminal of acceptance up to a predetermined minimum distance. This distance can be determined easily by means of suitable wireless communication protocols and standards. Especially preferred is the contact-free exchange of data with the terminal of acceptance for entering the first identification information using standard radio-frequency (wireless) methods, for example by using the NFC standard (NFC for Near Field Communication).

The electronic chip or RFID tag is provided to the user in particular only after a successful registration has been accomplished at the central server. According to a further related aspect of the present invention, this can in particular also be in the form of a sticker of a payment card or bank card of the user, in particular a sticker, which is configured for an rf-communication according to the NFC standard.

According to another preferred aspect of the invention the second identification information to be entered by the user is a static information, which is also suited and used for other identification or authentication methods, in particular a PIN (Personal Identification Number) uniquely associated to the card data of the user. Even elderly users are familiar with PIN-based identification methods, so that the process of the present invention can also be used to leverage existing infrastructure and identification procedures.

For entering or inputting the first identification information and/or the second identification information, the terminal of acceptance may comprise in particular an encrypting PIN keypad (EPP) for entering a personal confidential identification number (PIN). In general, however, also graphical input methods may be used for this purpose as an alternative or additionally, for example by displaying an identification matrix code, which is displayed on a display of a mobile telecommunication terminal of the user, e.g. on the display of a smartphone.

The terminal of acceptance may in particular be a banking terminal or an automatic teller machine (ATM), but also a payment terminal of a point-of-sale (POS) system that can also be connected via an interface such as an USB-interface or secure interface with an existing POS terminal, which in turn communicates with a service host via a secure communication link.

As stated above, a further aspect of the present invention relates to software for execution of the above process, if software code portions of this software are executed by processors of the terminal of acceptance and of the host.

According to another aspect of the present invention there is provided a service computer or host embodied as a central server (host) for carrying out the above process. A database is associated or connected with the host, at least for storing the user identification information (user-ID), the telecommunication number and the card data of the user, if the user has been registered successfully at the central server. Furthermore, the service computer or host also comprises an interface module for communication with the terminal of acceptance via a confidential (secure) channel for the transmission of information, in particular for transmitting the first identification information, to the telecommunications number assigned to the user and stored in the database. Furthermore, the host comprises an authenticating unit configured for executing the above process.

According to a further related aspect of the present invention a terminal of acceptance is provided which is configured for card-free authentication of a user by means of the above process.

According to a further related aspect of the present invention a system is provided that is configured for carrying out the aforementioned process for card-free authentication of a user at a terminal of acceptance.

### BRIEF DESCRIPTION OF THE DRAWINGS

The invention will be disclosed hereinafter in an exemplary manner and with reference to the accompanying drawings, from which further advantages, features and problems to be solved may be derived. In the drawings:

FIG. 1 is a schematic flow diagram of a method for card-free authentication of a user according to the present invention;

FIG. 2 shows a system with a banking machine or an automatic teller machine (ATM) to perform the process according to a first aspect of the present invention;

FIG. 3 shows a system with a point-of-sale (POS) terminal for performing a process according to a second aspect of the present invention;

FIG. 4 is a block diagram showing components of a host server to perform the process according to the present invention.

In the drawings, identical reference numerals designate identical or substantially equivalent elements or element groups.

### DETAILED DESCRIPTION OF THE PREFERRED EMBODIMENTS

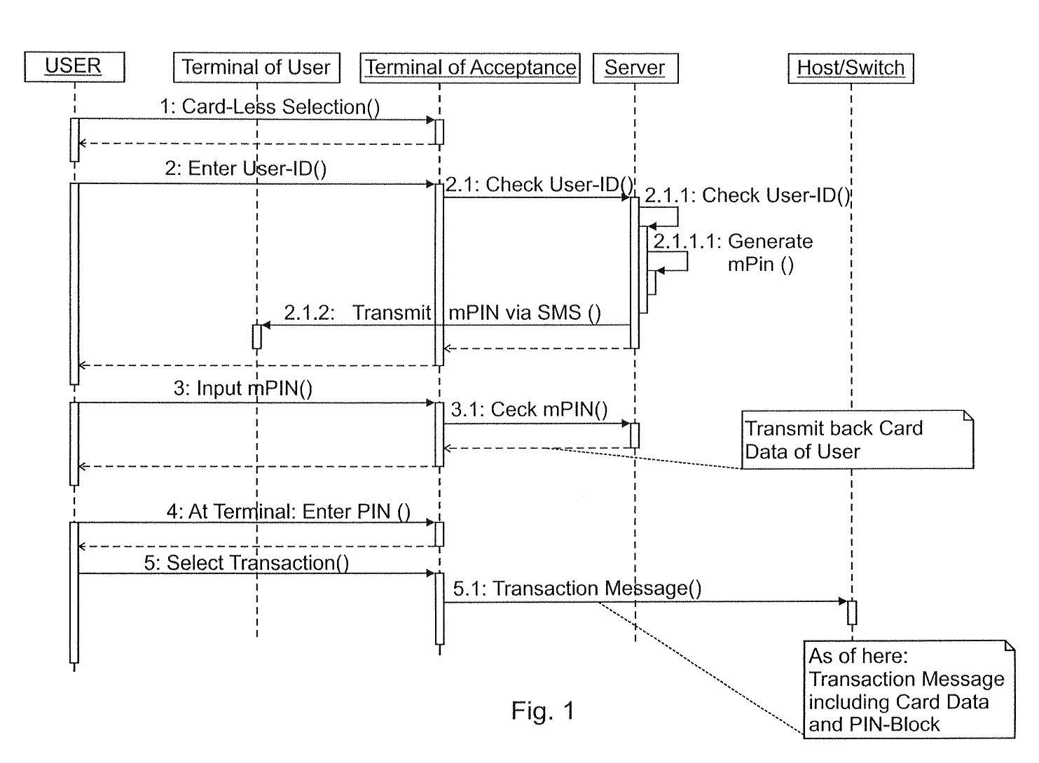

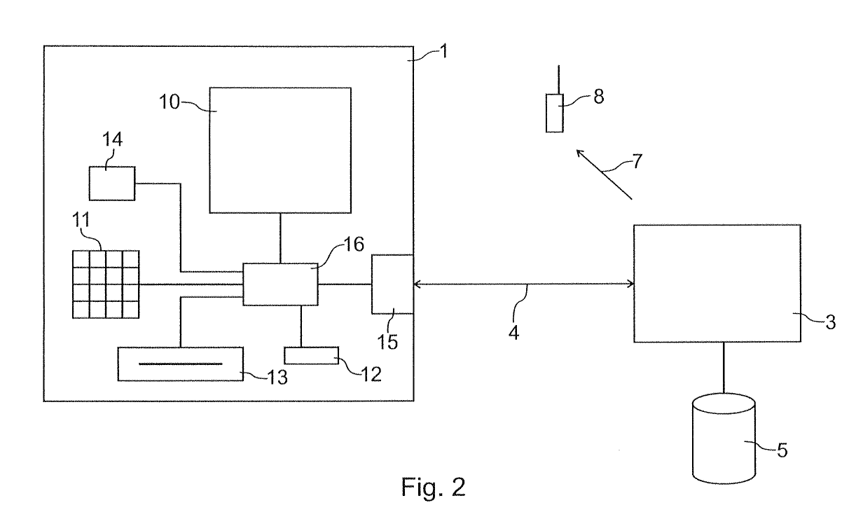

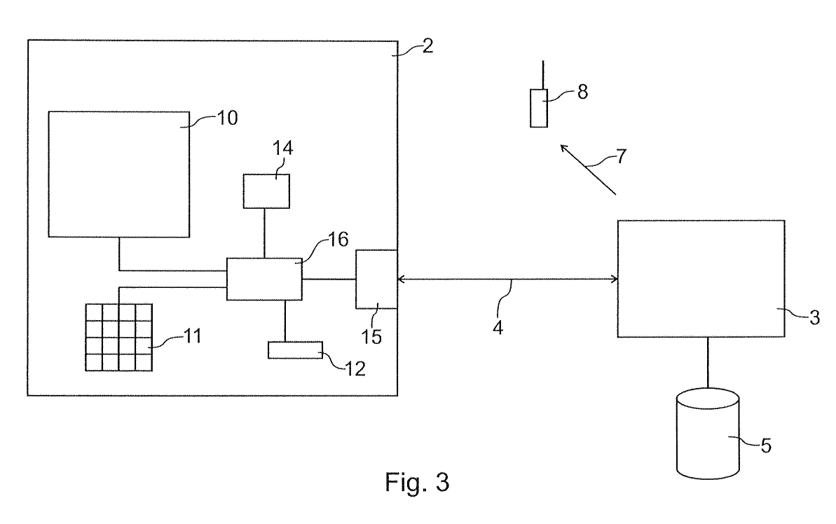

FIG. 1 illustrates schematically the process of a transaction at a terminal of acceptance, such as a banking machine, banking terminal, an automatic teller machine (ATM) or a point-of-sale (POS) payment terminal. For this purpose, the user must have been registered beforehand at a central location (server). This is accomplished via any suitable measures, for example, in writing, at the bank office, by postal identification procedures (e.g. in Germany so-called Postldent procedure), etc., wherein this necessary information is collected and stored at the central location (server) under assignment to the user, especially with a user identification information (hereinafter referred to also as user-ID), with a telecommunications number uniquely assigned to the user and card data of the bank card or payment card used by the user. Ideally, the user is registered at the central server in addition with a bank account and the central server is part of a banking system of a financial institution. The data associated with the user are stored in a database 5 (cf. FIGS. 2 and 3) of the central server, under assignment to the user. Data of the user can of course be changed at the central server if required, e.g. the telecommunications number or the user identification information, but only in a confidential manner and by use of secured methods and procedures, for example, at a bank counter or the like, as outlined above.

The user identification information (user-ID) is provided to the user by the central location (server) upon successful registration, for example in the form of numeric or alphanumeric information, such as a personal identification number (PIN), wherein the transmission of this user-ID to the user is accomplished, for example by e-mail, standard or registered mail, SMS or the like. Alternatively or additionally, the user identification information can be provided to the user also in the form of electronically readable information and/or electronically readable components, particularly by means of an electronic chip, integrated circuit or RFID tag carried by the user and suited for contact-free exchange of data with the terminal of acceptance. The data and user identification information may be made available to the user in particular as a label for a bank card or payment card carried by the user. Such a chip, integrated circuit or RFID tag can be configured especially for wireless communication using the NFC (near field communication) standard.

In order be entitled to use of the terminal of acceptance, the user must first be authenticated and authorized to execute a transaction. For this purpose in step 1 (card-free selection) a card-free input or query of a first identification information is executed, e.g. the input or query of the user-ID. For example, the user enters the user identification information (user-ID) as a first identification information using an EPP (Encrypting PIN Pad) of an ATM or of a banking machine. Or the user identification information recorded on an electronic chip or RFID tag carried by the user is communicated to the terminal of acceptance using wireless communication protocols, for example according to the NFC standard. In particular this communication is accepted only after the user has approached the terminal of acceptance up to a predetermined minimum distance, which according to a preferred embodiment can be less than about ten centimeters, wherein the data exchange between the electronic chip or RFID tag and the terminal of acceptance may be an active-active process or an active-passive process. The use of the NFC standard has also been found to be advantageous because NFC-enabled mobile phones will be available to a large extent on the market and will in particular be supported by the Android operating system by Google, but other vendors such as Apple and Samsung also intend to support NFC in the future. The wireless communication is performed here in an appropriate frequency range, for example, at a frequency of 13.56 MHz.

As an alternative, a graphical information can also be used as the first identification information, for example an identification matrix code that is displayed on a display of a mobile telecommunication terminal of the user and is presented or displayed to a graphical input panel or to an optical detection means of the terminal of acceptance.

After entering or transmission of this first identification information (step 2: Enter User-ID), this information and/or any information derived or processed based on this first identification information in accordance with a predetermined calculation rule or algorithm is communicated to the central server or the host via a secure communication link 4 (cf. FIG. 2), where on the basis of this first identification information as transmitted and/or on the basis of any information derived or computed based on this first identification information and using the data stored at the central server for the user it is determined, whether the user can be successfully identified (steps 2.1 “checkUser-ID” and 2.1.1 “check User-ID”).

In the case of a successful identification, i.e. if the first identification information communicated to the central server matches with or corresponds to the information stored at the central server for the user, the central server generates a user identification message (step 2.1.1.1: generate mPIN), which is then communicated to the telecommunication number assigned to the user identification information by means of another telecommunications service. This user identification message may be a numeric or alphanumeric information, but may also be or include additionally or as an alternative graphical identification information, such as a matrix identification code. According to another preferred embodiment a mobile PIN (mPIN) is communicated. This user-identification message is communicated via a suitable telecommunications service, preferably via a mobile short message service in the form of an SMS (Step 2.1.2 “send mPIN via SMS”).

The User-ID message (user identification message) transmitted to the user is displayed on the mobile telecommunication terminal of the user and is input to the terminal of acceptance by the user upon request by the terminal of acceptance, for example by entering the transmitted mPIN using an EPP of a banking terminal or ATM (step 3: “Enter mPIN”). In general it is conceived that this input is accomplished by entering a graphical identification information, for example by displaying an identification matrix code on a display of the mobile telecommunication terminal of the user and presenting the same to an optical detection panel or to an optical detection means of the terminal of acceptance.

The user identification message, which has been entered or input in the manner as outlined above, is transmitted by the terminal of acceptance sent to the central server, where it is checked, i.e. where it is compared with the user identification message sent to telecommunications number assigned to the user (step 3.1 “check mPIN”). If the user identification message input by the user into the terminal of acceptance, which has been transmitted by the terminal of acceptance to the central server via a secure communication link, matches with the user identification message sent by the central server or corresponds to this user identification message, then a further authentication of the user at the terminal of acceptance is permitted and can be performed by means of a second identification information, for instance in the standard manner by entering the personal identification number (PIN) in step 4 of FIG. 1 (Step 4: “SB input”). For this purpose also the card data of the user can be transmitted to the terminal of acceptance via the secure communication link (intermediate step: “Return card data of the user”), where the further authentication is then accomplished using the second identification information.

After successful authentication and after step 4 (“SB PIN Entry”) then the desired transaction can be ordered by the user in step 5 (“transaction selection”), for example, a cash payment, bank transfer, a function for printing a bank statement, but also payment functions, for example at a point-of-sale (POS) terminal. The transaction assigned to this transaction message is then transmitted back to the central server in step 5.1 (“transaction message”), for example, for billing purposes.

FIG. 2 shows a system for carrying out the method described above using a first exemplary embodiment of a terminal of acceptance, which is in this case a banking terminal or an ATM 1, which comprises a display 10, a keyboard 11 (also an Encrypting PIN Pad (EPP)), a card reader, a cash input unit and/or cash dispenser unit 13 and a communication interface 15 for communication with the central server 3 via a secure communication link 4. In addition, the ATM 1 may also comprise a wireless communication module 14, for wireless communication with an electronic chip, RFID tag or the like carried along by the user. These components and processes are controlled by a central processor 16 of the banking terminal or ATM 1. The communication via the communication link 4 is a secure communication process, in particular by means of suitable encryption algorithms. The central server 3 comprises a host and is connected with a database 5, where the data of the users of the service provider (e.g. of a bank) are stored. The central server 3 may transmit the above-mentioned user identification message 7 via a separate communication link, in particular via a mobile telecommunications service, to a telecommunication terminal 8 of the user that corresponds to the telecommunication number stored at the central server 3 for each user. The telecommunications terminal may preferably be a mobile telecommunications device such as a mobile phone, smartphone, tablet PC with telephone functionality, or the like.

If an unauthorized party obtains the user identification information surreptitiously but cannot, however, obtain control over the telecommunications terminal 8, then the first identification information, which is transmitted by the central server to the telecommunications terminal 8 upon entry of the user identification information at the terminal of acceptance 1, would be sent to the actually authorized user, who would then be forewarned, since because he or she actually did not intend to perform any transaction, and who then can take the appropriate countermeasures such as blocking of the banking card, blocking the SIM card of the telecommunications terminal 8, informing the police, etc. Conversely, the identification of the user at such a banking terminal or ATM is performed in a card-free manner by entering the user identification message transmitted to the terminal 8 and a second identification information, in particular a personal identification number (PIN) of the user normally used for other banking services.

FIG. 3 illustrates another embodiment for performing the authentication process at a terminal of a cashier system. For this purpose the point-of-sale (POS) terminal 2 or a data input device connected thereto via a cable connection, which is preferably a secure cable communication, comprises a display 10, a keyboard 11 for entering numeric or alphanumeric information (also an EPP), a card reader 12 and a communication interface 15 to configured to communicate with the central server 3 via a secured communication link 4. In addition, the POS terminal 2 may also comprise a wireless communication module 14. These components are controlled by a central processor 16.

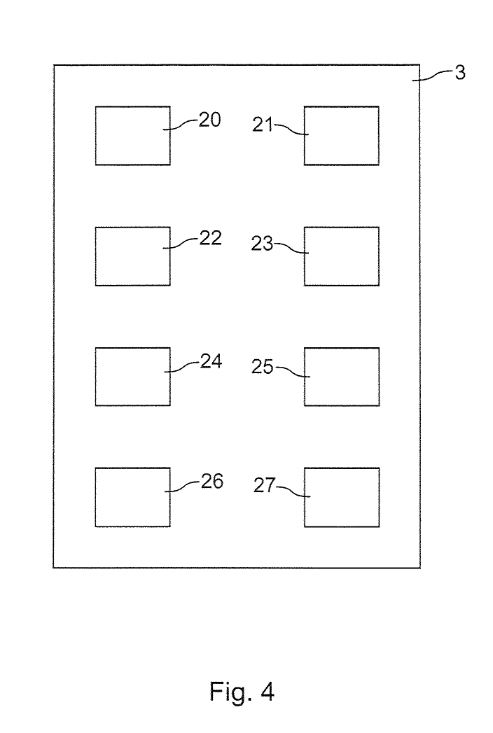

FIG. 4 shows the important components of a central location (server), for example a computer host of a bank. The central server 3 comprises an interface module 20 for communication with the terminal of acceptance via a secure communication link 4 (see FIGS. 2 and 3) and for communication with the telecommunication terminal 8 of the user via the additional communication channel 7 (cf. FIGS. 2 and 3). Furthermore, the central server 3 comprises a generator for the user identification message 21 to be communicated to the telecommunications number assigned to the user, for example by means of a mPIN (mobile PIN). Furthermore, the central server 3 comprises an authentication unit 23, which is configured for performing an identification and authentication of the user according to the afore-mentioned method, a transaction unit 24, which monitors the transaction to be performed by the terminal of acceptance or analyzes the transaction messages performed by the terminal of acceptance and transmitted back from the terminal of acceptance and further processes this message, a blocking unit 25, which can block the terminal of acceptance so that the terminal of acceptance can be blocked in the case of failure to authenticate the user so that the transaction requested is not performed, a central processor 26 and an interface module for communication with a data base or other hosts.

The method outlined above is particularly suited for performing a rapid and secure transaction using card-free authentication of the user, preferably by means of SMS-messages to a mobile phone of a user registered at the central server. Hence, the persons involved only need to carry along and use a mobile telecommunications terminal in order to be able to use the afore-mentioned services. Requesting and permitting such services as well as performing transactions via mobile telecommunication enables numerous embodiments, which have been illustrated in the above description referring to exemplary embodiments. Further embodiments will be readily apparent to the skilled person upon studying the above description and shall be covered by the appended as long as they do not deviate from the general approach and scope scope of the invention as outlined above and defined in the appended claims.

What is claimed is:

1. A process for card-free authentication of a user at a terminal of acceptance, for executing a transaction at or by means of the terminal of acceptance, wherein the user is registered at a central server by means of a user identification information, which is available to the user, a telecommunications number and of card data, comprising wherein:
the terminal of acceptance transmits a first identification information entered by the user at the terminal of acceptance or prompted by the terminal of acceptance and/or an information derived from first identification information to the central server;
the central server transmits a user identification message to the telecommunications number assigned to the user identification information, if the user has been successfully identified by the central server based on the transmitted first identification information and/or based on the derived information;
the terminal of acceptance prompts the user to enter the user identification message transmitted; and
the user is authenticated using a second identification information and is authorized to execute the transaction, if the user identification message entered by the user at the terminal of acceptance corresponds to user identification message transmitted by the central server.

2. The process according to claim 1, wherein the user identification message is transmitted to a mobile telecommunication terminal that corresponds to the telecommunication number via a telecommunications service, and wherein the telecommunication number is a phone number or an IP-address.

3. The process according to claim 2, wherein the telecommunications service is a mobile short message service and the user identification message is an SMS with numeric or alphanumeric information.

4. The process according to claim 2, wherein the telecommunications service is a wireless Internet-based telecommunications service and the user identification message is an e-mail with numeric or alphanumeric information or with an identification matrix code, which can be retrieved and displayed on the mobile telecommunication terminal.

5. The process according to claim 1, wherein the user identification information is a numeric or alphanumeric user-ID that is notified to the user after a successful registration at the central server, in particular by means of an e-mail or in writing.

6. The process according to claim 1, wherein the user identification information is stored on an electronic chip or on RFID tag carried along by the user, which is configured for a contact-free exchange of data with the terminal of acceptance, in particular using an NFC standard (Near Field Communication).

7. The process of claim 6, wherein the electronic chip or RFID tag is provided to the user as a sticker for a payment card carried along by the user after successful registration at the central server.

8. The process according to claim 6, wherein an approach of the electronic chip or RFID tag to the terminal of acceptance to less than a predetermined minimum distance is determined by the terminal of acceptance as an attempt for contacting the terminal of acceptance for triggering transmission of the user identification information stored on the electronic chip or RFID tag, which is used as the first identification information.

9. The process according to claim 1, wherein the central server compares this first identification information transmitted and/or the information derived from this first identification information in accordance with a predetermined algorithm and transmitted to the central server with the user identification information stored at the central server for the user and/or with an information derived based on this user identification information in accordance with a predetermined algorithm, wherein the user is successfully identified only in case of a match.

10. The process according to claim 9, wherein the central server indicates an identification of the terminal of acceptance, which has been successful or not successful, by sending a message and/or transmits the card data to the terminal of acceptance, if the identification has been successful.

11. The process according to claim 1, wherein the second identification information is static information associated with the user, in particular a PIN uniquely assigned to card data of the user.

12. The process according to claim 1, wherein the terminal of acceptance is a banking terminal or an ATM having an Encrypting PIN Pad (EPP) or a payment terminal of a point-of-sale (POS) system.

13. Comuter software comprising software code portions for causing an execution of the process according to claim 1, when the software code portions are executed by processors.

14. A host as a central server for a system for card-free authentication of a user at a terminal of acceptance, comprising:
a database for storing a user identification information available to the user, a telecommunication number and card data, wherein the user is registered at the central server under assignment of the user identification information, the telecommunications number and the card data;
an interface module for communicating with the terminal of acceptance via a secure channel and for transmitting information to the telecommunication number associated with the user via a telecommunications service, and
an authentication unit for authenticating the user and for authorizing the user for executing a transaction at or by means of the terminal of acceptance; wherein
the authentication unit is configured for identifying a user based on a first identification information input by the user at the terminal of acceptance or based on a first identification information prompted by the terminal of acceptance and/or based on an information derived from this first identification information, which is transmitted to the central server;
causing the host to transmit a user identification message to the telecommunication number associated with the user identification information via the telecommunications service, if the user has been identified successfully based on the transmitted first identification information and/or based on the derived information;
for informing the terminal of acceptance about the transmission of the user identification message to the telecommunication number associated with user identification information;
authenticating the user based on a second identification information, which the user enters into the terminal of acceptance after receiving the user identification message and when prompted by the terminal of acceptance, and for authorizing the user for executing the transaction if the user identification information entered by the user at the terminal of acceptance and transmitted to the host via the secure channel corresponds to the user identification message that has been transmitted by the central server.

15. The host of claim 14, wherein the interface module is configured for transmitting the user identification message to a mobile telecommunication terminal via the telecommunications service, wherein the telecommunication number corresponds to a phone number or an IP address.

16. The host of claim 14, wherein the authentication unit is further configured for comparing the transmitted first identification information and/or the information derived therefrom in accordance with a predetermined calculation rule and transmitted with the user identification information stored for the user in the data base and/or with an information derived from the transmitted user identification information in accordance with the predetermined calculation rule and for successfully identifying the user only in case of a match.

17. The host of claim 16, wherein the authentication unit is further configured for indicating a successful or unsuccessful identification to the remote terminal of acceptance by transmitting a message and/or for transmitting the card data to the terminal of acceptance, if the identification the user is successful.

18. A terminal of acceptance, configured for a card-free authentication of a user and for executing a transaction at or by means of the terminal of acceptance, wherein the user is registered at the central server under assignment of a user identification information available for the user, a telecommunications number and of card data, said terminal of acceptance being configured for:
transmitting information input by the user at the terminal of acceptance or prompted by the terminal of acceptance and/or information derived from this information to the central server;
prompting the user to enter a user identification message that was transmitted to the telecommunications number associated with the user identification message, if the user has been identified successfully by the central server based on the transmitted first identification information and/or based on the derived information;
prompting the user to enter a second identification information, authenticating the user using the second identification information and authorizing the user for executing the transaction if the user identification message entered by the user at the terminal of acceptance corresponds to the user identification message transmitted by the central server.

19. The terminal of acceptance of claim 18, wherein the terminal of acceptance is a banking terminal or ATM having an Encrypting PIN Pad (EPP) or a payment terminal of a point-of-sale (POS) system.

20. A system for card-free authentication of a user at a terminal of acceptance, for executing a transaction at or by means of the terminal of acceptance, comprising a central server, where the user is registered under assignment of a user identification information available for the user, a telecommunications number and card data, and at least one terminal of acceptance for executing the transaction, wherein the respective terminal of acceptance communicates with the central server via a secure channel, comprising wherein:
the respective terminal of acceptance is configured for prompting the user to input a first identification information request or for automatically prompting the first identification information and for transmitting the first identification information entered or prompted and/or an information derived therefrom to the central server via the secure channel;
the central server is configured for transmitting a user identification message to the telecommunication number associated with the user identification information via the telecommunications service, if the user has been identified successfully by the central server based on the transmitted first identification information and/or based on the derived information, and
informing the respective terminal of acceptance about the transmission of the user identification message to the telecommunication number associated with user identification information;
the respective point of sale is further configured for prompting the user to enter the transmitted user identification message and for transmitting to the user identification message entered by the user to the central server; and
wherein the central server or the respective terminal of acceptance is further configured for authenticating the user based on a second identification information entered at the terminal of acceptance, and for authorizing the user to carry out the transaction if the user identification message entered by the user at the terminal of acceptance corresponds to the user identification message transmitted by the central server.

21. The system of claim 20, wherein the user identification message is transmitted via the telecommunications service to a mobile telecommunication terminal that corresponds to the telecommunication number, wherein the telecommunication number is a phone number or an IP address.

22. The system according to claim 20, wherein the authentication unit is further configured for comparing the first identification information transmitted and/or the information derived therefrom according to a predetermined calculation rule and transmitted with the user identification information stored at the central server for the user and/or with an information derived therefrom in accordance with the same predetermined calculation rule and for identifying the user only in case of a match.

23. The system of claim 22, wherein the central server is further configured for indicating a successful or unsuccessful identification to the remote terminal of acceptance by transmitting a message and/or by transmitting the card data to the terminal of acceptance, if the identification of the user is successful.
